(19) United States
(12) Patent Application Publication
(10) Pub. No.: US 2025/0341275 A1
(43) Pub. Date: Nov. 6, 2025

(54) DISPLAY DEVICE

(71) Applicant: LG ELECTRONICS INC., Seoul (KR)

(72) Inventors: Taesung CHA, Seoul (KR); Jihoon YOON, Seoul (KR); Juhun LEE, Seoul (KR); Hyeongjun KWON, Seoul (KR); Dongkyoon HAN, Seoul (KR); Younghoon KIM, Seoul (KR)

(73) Assignee: LG ELECTRONICS INC., Seoul (KR)

(21) Appl. No.: 18/867,637

(22) PCT Filed: May 30, 2022
(86) PCT No.: PCT/KR2022/007639

§ 371 Date: Nov. 20, 2024

(30) Foreign Application Priority Data
May 20, 2022 (KR) 10-2022-0062194

(51) Int. Cl. F16M 11/08; F16M 11/18

(52) U.S. Cl. CPC F16M 11/08; F16M 11/18; F16M 2200/024; F16M 2200/08

(57) ABSTRACT

A display device comprises: a display set; and a swiveling mechanism connected to the display set, wherein the display set comprises a display body and a stand connected to the display body, and the swiveling mechanism comprises: a swivel top plate coupled to the stand; a swivel top bracket disposed under the swivel top plate and having a first gear; a swivel bottom bracket having a second gear with which the first gear is detachably meshed; a swivel bottom plate fastened to the swivel bottom bracket; an elastic member provided at the bottom surface of the swivel bottom plate and placed on an installation surface; a stopper plate disposed at the bottom surface of the swivel bottom plate; a bolt passing through the swivel top plate, the swivel top bracket, and the stopper plate; a nut coupled to the bolt; and a spring supported by the swivel bottom plate and elastically deformed by the stopper plate.

### TECHNICAL FIELD

The present invention relates to a display device.

### BACKGROUND ART

A swivel unit in which the display body is coupled to a base so as to be swivelable relative to an installation surface is disclosed in Korean Patent Publication No. 10-0609852 B1 (published on Aug. 8, 2006), and the swivel unit is provided on a lower area of the base to enable the display body to be swiveled about a vertical axis relative to the base with respect to the display device, and also, the swivel unit includes a swivel member coupled to a bottom surface of the base by a screw or the like, and a swivel support having one side supported on the installation surface and the other side slidably provided between the swivel member and the base so that the swivel member is supported to be swiveled.

The swivel support has a lower support portion seated on the installation surface such as a table and an upper support portion provided at an upper side of the lower support portion to extend to be inserted between the swivel member and a lower base cover, and a contact pad that prevents noise and slipping from occurring when being in contact with the installation surface is provided on a bottom surface of the lower support portion.

When a user presses the display body or the base to rotate around a vertical axis line, the swivel member coupled to the base is swiveled around the vertical axis line with respect to the swivel support seated on the installation surface.

### DISCLOSURE OF THE INVENTION

### Technical Problem

An object of the present invention is to provide a display device in which an entire display set including a display body and a stand are swiveled.

Another object of the present invention is to provide a display device capable of returning to its original position when a display set is lifted in a state in which an entire display set is swiveled.

### Technical Solution

A display device according to this embodiment may include: a display set; and a swiveling mechanism connected to the display set,

The display set may include a display body and a stand connected to the display body.

The swiveling mechanism may include: a swivel top plate coupled to the stand; a swivel top bracket disposed below the swivel top plate and having a first gear; a swivel bottom bracket having a second gear with which the first gear is detachably engaged; a swivel bottom plate coupled to the swivel bottom bracket; an elastic member provided at a bottom surface of the swivel bottom plate and placed on an installation surface; a stopper plate disposed on the bottom surface of the swivel bottom plate; a bolt passing through the swivel top plate, the swivel top bracket, and the stopper plate; a nut coupled to the bolt; and a spring supported by the swivel bottom plate and elastically deformed by the stopper plate.

The first gear may be disposed on a bottom surface of the swivel top bracket, and the second gear may be disposed on a top surface of the swivel bottom bracket.

A bolt through-hole through which the bolt passes may be defined in each of the swivel top plate, the swivel top bracket, and the stopper plate.

An accommodation portion in which the stopper plate is accommodated may be provided in the swivel bottom plate.

A space in which the accommodation portion is accommodated may be defined between the swivel top bracket and the stopper plate.

In the swivel bottom bracket, an opening that surrounds the accommodation portion may be defined larger than the accommodation portion.

A spring space in which the spring is accommodated may be defined between the swivel top bracket and the swivel bottom plate.

The spring may include: a spring body; a first bent portion bent at one side of the spring body; and a second bent portion bent at the other side of the spring body.

A first latch that is in contact with the first bent portion and the second bent portion may be provided on the swivel bottom plate.

A second latch that is in contact with one of the first bent portion and the second bent portion may be provided on the stopper plate.

The second latch may be disposed to face the first latch in a horizontal direction.

An accommodation groove in which an upper end of the first latch and an upper end of the second latch are accommodated may be defined in a bottom surface of the swivel top bracket.

A swivel bottom plate accommodation portion into which the swivel bottom plate is inserted to be accommodated may be defined in the swivel bottom bracket.

A stopper portion may protrude from the swivel bottom plate, and a stopper groove hooked with the stopper portion when the swivel top plate excessively rotates may be defined in the swivel top plate.

A stopper portion through-hole through which the stopper portion passes may be defined in the swivel bottom bracket.

### Advantageous Effects

According to the embodiment of the present invention, the entire swivel set may be swiveled, and when being swiveled frequently, only the swiveling mechanism may be replaced or repaired without repairing or replacing the display set, and there may be the advantage in that the repair or replacement operation is easier than when the display set is repaired or replaced.

In addition, the first and second gears may restrict the rapid swivel of the display set and allow the display set to be swiveled smoothly.

In addition, when the display set is lifted in the state in which the entire display set is swiveled, it may return to its original position by the spring.

In addition, the stopper plate may be accommodated in the accommodation portion provided in the swivel bottom plate to minimize the vertical thickness of the swiveling mechanism, and the stopper plate may be protected by the swivel bottom plate.

In addition, the opening defined in the swivel bottom bracket may surround the accommodation portion to minimize the vertical thickness of the swiveling, thereby protecting the accommodation portion by the swivel bottom bracket.

In addition, the simple structure of the stopper portion and the stopper groove may prevent the excessive rotation of the display set.

### BRIEF DESCRIPTION OF THE DRAWINGS

FIG. 1 is a front view of a display device according to this embodiment,

FIG. 2 is a plan view of the display device according to this embodiment,

FIG. 3 is a bottom view of the display device according to this embodiment,

FIG. 4 is a perspective view of a swiveling mechanism according to this embodiment,

FIG. 5 is an exploded perspective view of the swiveling mechanism according to this embodiment,

FIG. 6 is a bottom view of the swiveling mechanism according to this embodiment,

FIG. 7 is a plan view of the swiveling mechanism according to this embodiment,

FIG. 8 is a cross-sectional view taken along line A-A of FIG. 4,

FIG. 9 is a cross-sectional view when the swiveling mechanism is lift upward according to this embodiment,

FIG. 10 is a plan view of a spring according to this embodiment,

FIG. 11 is a bottom view before the swiveling mechanism is swiveled according to this embodiment, and

FIG. 12 is a bottom view while the swiveling mechanism is swiveled according to this embodiment.

### MODE FOR CARRYING OUT THE INVENTION

Hereinafter, detailed embodiments will be described in detail with reference to the accompanying drawings.

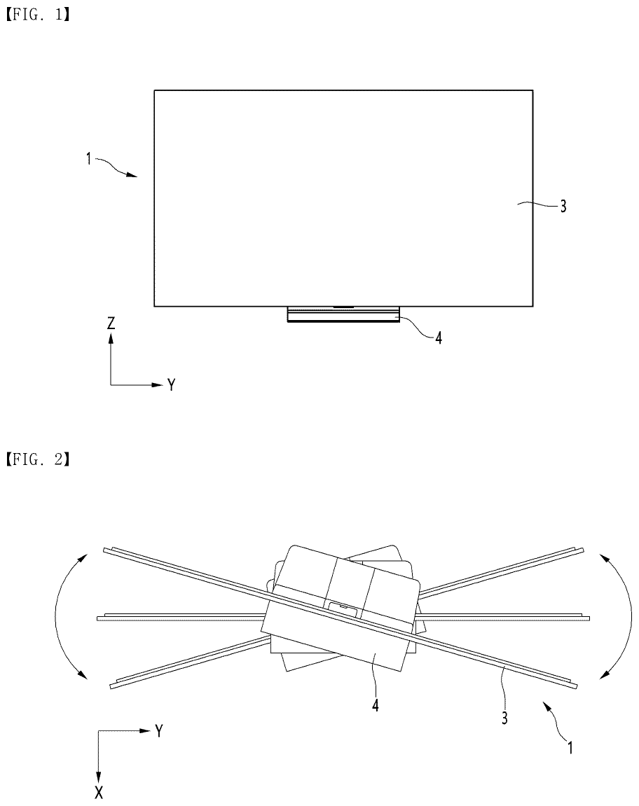

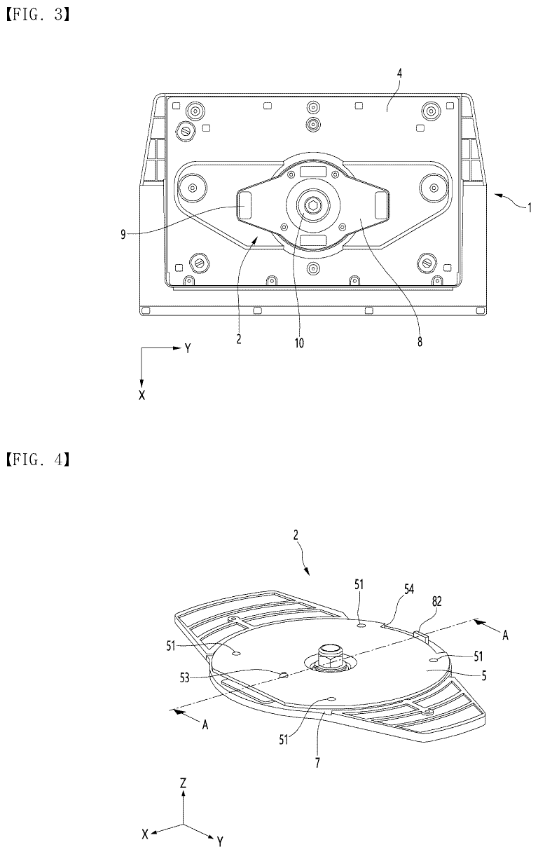

FIG. 1 is a front view of a display device according to this embodiment, FIG. 2 is a plan view of the display device according to this embodiment, and FIG. 3 is a bottom view of the display device according to this embodiment.

A display device may include a display set 1 and a swiveling mechanism 2 (see FIG. 3).

The display set 1 may include a display body 3 and a stand 4 connected to the display body 3. The display set 1 may be placed on the swiveling mechanism 2 and be swiveled in a clockwise or counterclockwise direction around the swiveling mechanism 2, as shown in FIG. 2.

The display body 3 may have a roughly rectangular display surface. Examples of the display body 3 may be a display panel such as an LCD, an LED, or a PDP.

The stand 4 may be connected to a rear surface of the display panel. A lower portion of the stand 4 may be exposed through a lower end of the display panel.

The swiveling mechanism 2 may be connected to the display set 1.

The swiveling mechanism 2 may be connected to the stand 4 and be connected to the stand 4 so as to be disposed at a lower side of the stand 4. The swiveling mechanism 2 may be smaller than the stand 4 and may be covered by the stand 4 when viewed from the above by a user or operator.

The swiveling mechanism 2 may be placed on an installation surface, and an example of the installation surface may be a top surface of a table or the like on which the display device is placed. When the swiveling mechanism 2 is placed on the installation surface, a load of the display set 1 may be transferred to the swiveling mechanism 2.

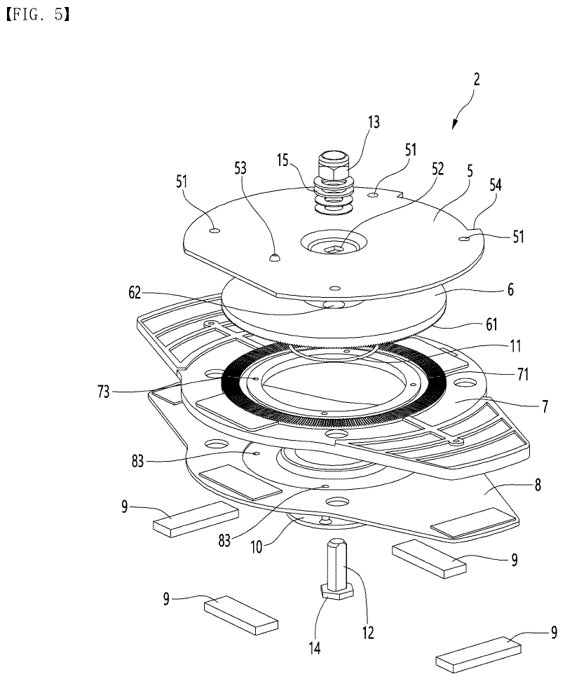

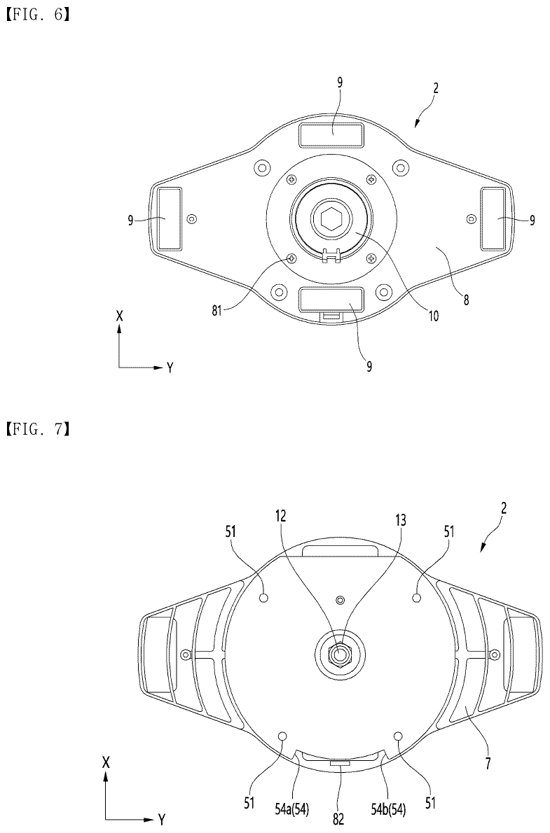

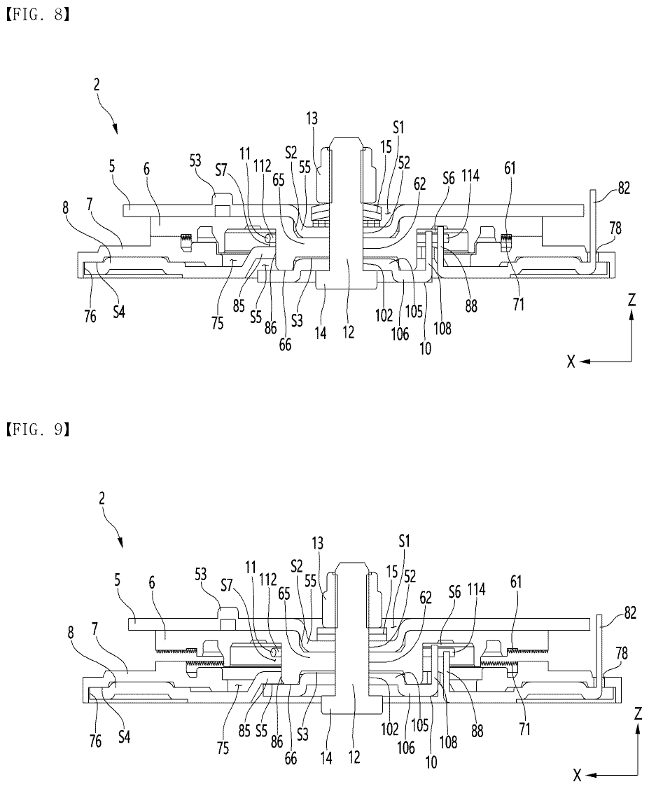

FIG. 4 is a perspective view of the swiveling mechanism according to this embodiment, FIG. 5 is an exploded perspective view of the swiveling mechanism according to this embodiment, FIG. 6 is a bottom view of the swiveling mechanism according to this embodiment, and FIG. 7 is a plan view of the swiveling mechanism according to this embodiment.

The swiveling mechanism 2 may include a swivel top plate 5, a swivel top bracket 6, a swivel bottom bracket 7, a swivel bottom plate 8, an elastic member 9, a stopper plate 10, and a spring 11.

The swivel top plate 5 may be provided in a shape that is roughly similar to a circular plate. The swivel top plate 5 may define an outer appearance of a top surface appearance of the swiveling mechanism 2.

The swivel top plate 5 may be disposed below the stand 4. The swivel top plate 5 may be coupled to the stand 4. The swivel top plate 5 may be coupled to the stand 4 using a coupling member (hereinafter, referred to as a coupling member) such as a screw. The swivel top plate 5 may be provided with at least one coupling hole 51 through which the coupling member passes. The coupling hole 51 may be defined to pass through the swivel top plate 5 in a vertical direction Z. The coupling hole 51 may be provided in plurality in the swivel top plate 5, and the plurality of coupling holes 5 may be defined to be spaced apart from each other.

An assembly guide 53 may be disposed on the swivel top plate 5. The assembly guide 53 may be provided to protrude at one side of a top surface of the swivel top plate 5. The mounting guide 53 may be inserted into a guide hole (not shown) defined in the stand 4, and the swivel top plate 5 may be coupled to the stand 4 as the coupling member while the assembly guide 53 is inserted into the guide hole.

A material of the swivel top plate 5 may be hot-rolled galvanized steel (HGI).

The swivel top bracket 6 may be disposed below the swivel top plate 5. The swivel top bracket 6 may have a size less than that of the swivel top plate 5. The swivel top bracket 6 may be protected by the swivel top plate 5. The swivel top bracket 6 may be disposed between the swivel top plate 5 and the swivel bottom bracket 6.

A first gear 61 may be provided on the swivel top bracket 6. The first gear 61 may be disposed on a bottom surface of the swivel top bracket 6. An overall shape of the first gear 61 may be a ring shape.

A material of the swivel top bracket 6 may be polyacetal (POM).

The swivel bottom bracket 7 may be provided with a second gear 71. The second gear 71 may be disposed on the top surface of the swivel bottom bracket 7. The second gear 71 may be separably engaged with the first gear 61.

When the swivel top bracket 6 is lifted upward, the first gear 61 may be separated from the second gear 71, and when the swivel top bracket 6 is pressed downward, the first gear 61 may be engaged with the second gear 71.

The first gear 61 and the second gear 71 may be engaged by a load of the display set 1, and when the display set 1 is swiveled, friction torque may be generated between the first gear 61 and the second gear 71 to allow the display set 1, the swivel top plate 5, and the swivel top bracket 6 to be swiveled.

If no external force is applied to the display set 1, the first gear 61 and the second gear 71 may be maintained in the engaged state.

A material of the swivel bottom bracket 7 may be polyacetal (POM).

The swivel bottom plate 8 may be coupled to the swivel bottom bracket 7. The swivel bottom plate 8 may be coupled to the swivel bottom bracket 7 using the coupling member 81 (hereinafter, referred to as the coupling member 81 (see FIG. 6)) such as a screw.

A lower coupling hole 83 (see FIG. 5) may be defined in the swivel bottom plate 8, and an upper coupling hole 73 (see FIG. 5) corresponding to the lower coupling hole 83 may be defined in the swivel bottom bracket 7. The lower coupling hole 83 may be defined to pass through the swivel bottom plate 8 in the vertical direction, and the upper coupling hole 73 may be defined to pass through the swivel bottom bracket 7 in the vertical direction. The coupling member 81 may pass through the lower coupling hole 83 and the upper coupling hole 73 to couple the swivel bottom plate 8 to the swivel bottom bracket 7. The swivel bottom plate 8 and the swivel bottom bracket 7 may be integrated by the coupling member 81.

A material of the swivel bottom plate 8 may be hot-rolled galvanized steel (HGI).

An elastic member mounting part on which the elastic member 9 is mounted may be provided on the bottom surface of the swivel bottom plate 8.

The elastic member 9 may be provided on the bottom surface of the swivel bottom plate 8 and may be placed on the installation surface.

The elastic member 9 may be attached to the swivel bottom plate 8 by an adhesive member such as a double-sided tape.

The elastic member 9 may be a contact pad that prevents noise and slipping when being in contact with the installation surface. A material of the elastic member 9 may be rubber.

The elastic member 9 may be provided in plurality in the bottom surface of the swivel bottom plate 8, and the plurality of elastic members 9 may be spaced apart from each other.

The user or operator may place the swiveling mechanism 2 on the installation surface in the state in which the swiveling mechanism 2 is coupled to the display set 1, and the elastic member 9 may restrict the swiveling mechanism 2 from slipping on the installation surface by exerting strong frictional force on the installation surface.

The stopper plate 10 may be disposed on the bottom surface of the swivel bottom plate 8. A size of the stopper plate 10 may be less than that of the swivel bottom plate 8 and may be hidden by the swivel bottom plate 8.

A material of the stopper plate 10 may be hot-rolled galvanized steel (HGI).

The spring 11 may be supported on the swivel bottom plate 8. The spring 11 may be disposed between the swivel bottom plate 8 and the swivel top bracket 6 in the vertical direction Z.

When the stopper plate 10 rotates, the spring 11 may be elastically deformed by the stopper plate 10, and when the external force applied to the spring 11 is removed, the spring 11 may be elastically restored.

The swiveling mechanism 2 may include a bolt 12 and a nut 13 coupled to the bolt 12. The swiveling mechanism 2 may further include at least one washer 15.

The bolt 12 may pass through the swivel top plate 5, the swivel top bracket 6, and the stopper plate 10.

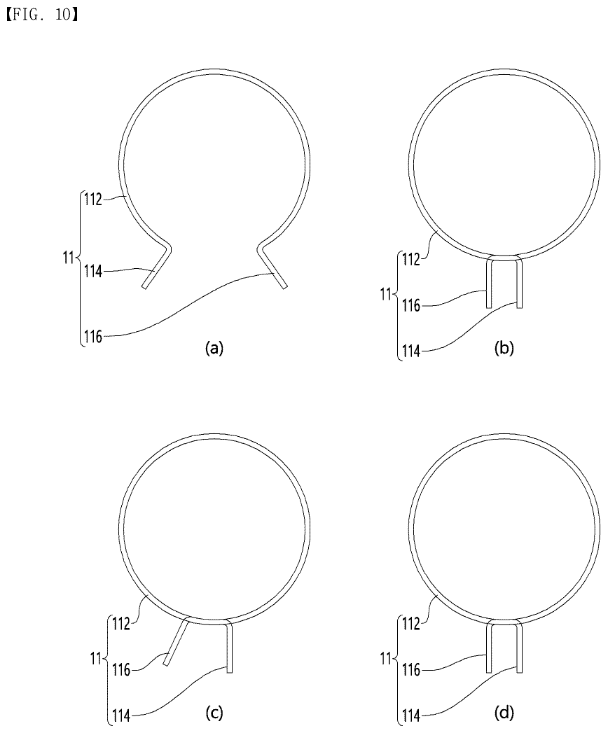

Bolt through-holes 52, 62, 102 (see FIG. 8) through which the bolts 12 pass may be defined in the swivel top plate 5, the swivel top bracket 6, and the stopper plate 10, respectively.

The bolt 12 may sequentially pass through the bolt through-hole 102 of the stopper plate 10, the bolt through-hole 62 of the swivel top bracket 6 and the bolt through-hole 52 of the swivel top plate 5, and the nut 13 may be coupled to a portion of the bolt 12, which is disposed above the bolt through-hole 52 of the swivel top plate 5.

The bolt 12 may function as a vertical central axis of the swiveling mechanism 2. The bolt 12 may have a bolt head 14 at a lower portion thereof. The bolt head 14 may be in contact with a peripheral portion of the bolt through-hole 102 of the stopper plate 10, and the stopper plate 10 may be hooked downward on the bolt head 14.

The nut 13 may be coupled to the bolt 12. The nut 13 may be coupled to an upper portion of the bolt 12. The swivel top plate 5, the swivel top bracket 6, and the stopper plate 10 may be restricted by the nut 12 and the bolt 12 between the nut 12 and the bolt head 14.

The swiveling mechanism 2 may include a stopper that prevents the display set 1 from rotating beyond predetermined angle. The stopper may include a stopper groove 54 and a stopper portion 82, as illustrated in FIG. 4 and FIG. 7.

The stopper portion 82 may protrude from the swivel bottom plate 8, and the stopper groove 54 that is hooked with the stopper portion 82 when the swivel top plate 5 excessively rotates may be defined in the swivel top plate 5.

The stopper groove 54 may be provided in a recessed shape in a portion of an outer circumference of the swivel top plate 5. The stopper groove 54 may be defined in a rear portion of front and rear portions of the swivel top plate 5 and may be provided in an arc shape. One end 54a or the other end 54b of the stopper groove 54 may be hooked on the stopper portion 82. A distance between the one end 54a and the other end 54b of the stopper groove 54 may be greater than a length of the stopper portion 82, as shown in FIG. 7.

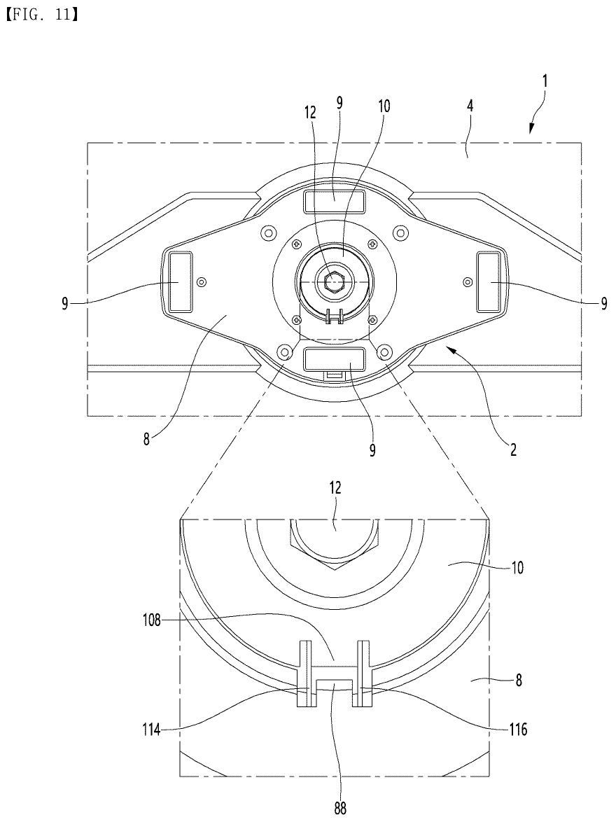

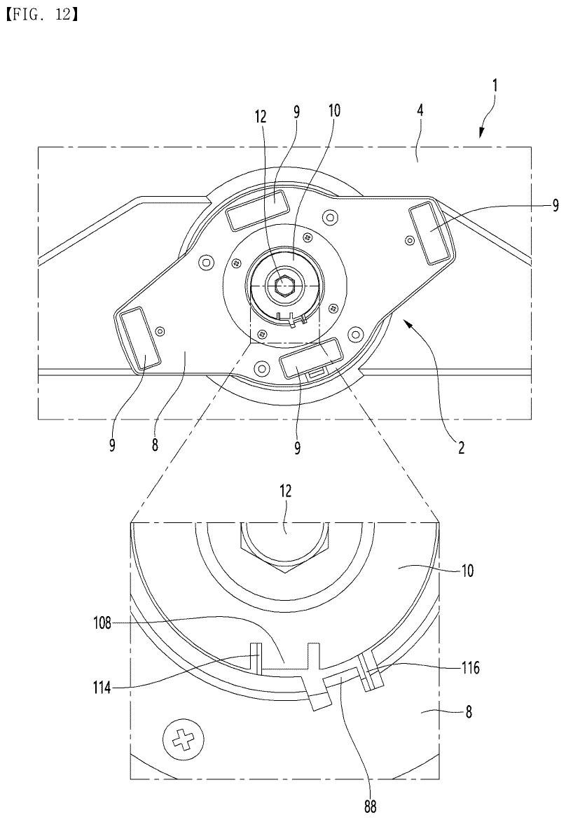

FIG. 8 is a cross-sectional view taken along line A-A of FIG. 4, FIG. 9 is a cross-sectional view when the swiveling mechanism is lift upward according to this embodiment, FIG. 10 is a plan view of the spring according to this embodiment, FIG. 11 is a bottom view before the swiveling mechanism is swiveled according to this embodiment, and FIG. 12 is a bottom view while the swiveling mechanism is swiveled according to this embodiment.

The swivel top plate 5 may be provided with an upper protrusion 55 that is bent to protrude downward.

The bolt through-hole 52 of the swivel top plate 5 may be defined to pass through the upper protrusion 55 in the vertical direction Z.

The upper protrusion 55 may be provided in a shape that is recessed downward in the top surface of the swivel top plate 5.

An upper accommodation groove S1 may be defined at an inner side of the upper protrusion 55, and a washer 15 may be accommodated in the upper accommodation groove S1. The washer 15 may be disposed between the upper protrusion 55 and the nut 13. The upper accommodation groove S1 may have an opened top surface. The upper accommodation groove S1 may be a washer accommodation groove in which the washer 15 is accommodated.

The upper protrusion 55 may be provided in a shape that protrudes downward on the bottom surface of the swivel top plate 5.

A coupling hole 51, which couples the swivel top plate 5 to the stand 4, and the assembly guide 53 may be provided other than the upper protrusion 55.

The swivel top bracket 6 may be provided with a lower protrusion 65 into which the upper protrusion 55 is inserted and accommodated. The lower protrusion 65 may be provided to be disposed below the upper protrusion 55. The lower protrusion 65 may have a shape that protrudes downward from the swivel top bracket 6.

The bolt through-hole 62 of the swivel top bracket 6 may be provided to pass through the lower protrusion 65 in the vertical direction Z.

The lower protrusion 65 may be provided in a recessed shape in the top surface of the swivel top bracket 6.

An upper protrusion accommodation groove S2 in which the upper protrusion 55 is accommodated may be defined in the lower protrusion 65. The upper projection accommodation groove S2 may have an opened top surface. When the upper protrusion 55 is inserted and fitted into the lower protrusion 65, the swivel top plate 5 may be connected to the swivel top bracket 6.

The lower protrusion 65 may be provided in a shape that protrudes downward on the bottom surface of the swivel top bracket 6. A lower accommodation groove S3 may be defined in the bottom surface of the lower protrusion 65 into which a bent portion 105 of the stopper plate 10 is inserted and accommodated. The lower accommodation groove S3 may have an opened bottom shape. The lower accommodation groove S3 may be a stopper plate accommodation groove in which an entire or portion of the stopper plate 10 is accommodated.

The lower protrusion 65 may be disposed in an inner area of the first gear 61.

The lower end 66 of the lower protrusion 65 may be in contact with the stopper plate 10.

The swivel bottom bracket 7 may have an opening 75 that surrounds the accommodation portion 85 of the swivel bottom plate 8. The opening 75 may be defined larger than the accommodation portion 85, and an entire or portion of the accommodation portion 85 may be accommodated in the opening 75. The opening 75 may be defined in an inner area of the second gear 71.

The swivel bottom bracket 7 may be provided with a swivel bottom plate accommodation portion 76 into which the swivel bottom plate 10 is inserted and accommodated.

The swivel bottom plate accommodation groove S4 into which the swivel bottom plate 10 is inserted and accommodated may be defined in an inner area of the swivel bottom plate accommodation portion 76. The swivel bottom plate accommodation groove S4 may have an opened bottom surface. The swivel bottom bracket 7 may surround a portion of the top surface and a circumferential surface of the swivel bottom plate 10.

A stopper portion through-hole 78 through which the stopper portion 82 passes may be defined in the swivel bottom bracket 7. The stopper through-hole 78 may be defined in an outer area of the second gear 71. The stopper portion through-hole 78 may be defined to pass through a rear portion of front and rear portions of the swivel bottom bracket 7 in the vertical direction Z.

The swivel bottom plate 8 may be provided with an accommodation portion 85 in which the stopper plate 10 is accommodated. An entire or portion of the stopper plate 10 may be inserted into and accommodated in the accommodation portion 85.

The accommodation portion 85 may be defined in a center of the swivel bottom plate 8.

The accommodation portion 85 may have a shape that is recessed upward.

The accommodation portion 85 may be inserted into the opening 75 of the swivel bottom bracket 7 and may be accommodated in the opening 75 of the swivel bottom bracket 7.

A through-hole 86 through which the lower protrusion 65 of the swivel top bracket 6 passes may be defined in the accommodation portion 85.

A space S5 in which the accommodation portion 85 is accommodated may be defined between the swivel top bracket 6 and the stopper plate 10.

The space S5 may be defined between the bottom surface of the swivel top placket 6 and the top surface of the stopper plate 10.

A portion of the accommodation portion 85 may be accommodated in the space S5, a portion of the accommodation portion 85 may be hooked downward on the lower plate 10, and the accommodation portion 85 may be maintained without being separated between the swivel top placket 6 and the stopper plate 10.

A first latch 88 may be disposed on the swivel bottom plate 8 that are in contact with a first bent portion 114 and a second bent portion 116. The first latch 88 may be disposed in the accommodation portion 85 and may be provided to protrude upward. The first latch 88 may be a latch that are in contact with and hooked with the first bent portion 114 and the second bent portion 116 together. Each of the first bent portion 114 and the second bent portion 116 may be deformed in a direction that is away from each other by the first latch 88.

The stopper plate 10 may be provided with a bent portion 105 at the center thereof. The bent portion 105 may be bent to protrude upward from the stopper plate 10.

The stopper plate 10 may include a contact part 106 that are in contact with the lower end 66 of the lower protrusion 65. The contact part 105 may protrude upward from the contact part 106.

A second catch 108 that is in contact with one of the first bent portion 114 and the second bent portion 116 may be disposed on the stopper plate 10. The second latch 108 may be provided to protrude upward from the contact part 106. The stopper plate 10 may be assembled so that the second latch 108 faces the first latch 88 in a horizontal direction. The second latch 108 may be a latch that is in contact with and hooked with the first bent portion 114 and the second bent portion 116 together.

An accommodation groove S6 may be defined in the bottom surface of the swivel top bracket 6 to accommodate an upper end of the first latch 88 and an upper end of the second latch 108.

(a) of FIG. 10 is a plan view before the spring is mounted, (b) of FIG. 10 is a plan view when the spring is mounted, (c) of FIG. 10 is a plan view when the spring is elastically deformed by the stopper plate, and (d) of FIG. 10 is a plan view when the spring is elastically restored.

The spring 11 may include a spring body 112, a first bent portion 114, and a second bent portion 116.

The spring body 112 may have an arc shape, as shown in (a) of FIG. 10, when no external force is applied to the first bent portion 114 and the second bent portion 116. An example of a spring body 112 may be a right arc shape.

The first bent portion 114 may be bent at one side of the spring body 112. The first bent portion 114 may be bent from one end of the spring body 112 toward the outside of the spring body 112.

The second bent portion 116 may be bent at the other side of the spring body 114. The second bent portion 116 may be bent from the other end of the spring body 112 toward the outside of the spring body 112.

The first bent portion 114 and the second bent portion 116 may be bent symmetrically.

When no external force is applied to the spring 11, the first bent portion 114 and the second bent portion 116 may be spaced apart from each other in a left and right direction, as shown in (a) of FIG. 10. If the first bent portion 114 is bent to the left direction, the second bent portion 116 may be bent to the right direction.

A spring space S7 in which the spring 11 is accommodated may be defined between the swivel top bracket 6 and the swivel bottom plate 8. The spring 11 may be accommodated between the bottom surface of the swivel top bracket 6 and the top surface of the accommodation portion 85, as shown in FIGS. 8 and 9.

Before the spring 11 is mounted between the bottom surface of the swivel top bracket 6 and the top surface of the accommodation portion 85, as shown in (b) of FIG. 10, one end of the spring body 112 and the other end of the spring body 112 may overlap each other, and the spring body 112 may be elastically deformed to have an overall ring shape. When the spring body 112 is elastically deformed, the first bent portion 114 and the second bent portion 116 may be exchanged in their left and right positions compared to before the elastic deformation. In this case, the first bent portion 114 may be a right-side bent portion, and the second bent portion 116 may be a left-side bent portion.

The first bent portion 114 and the second bent portion 116 may be supported on the swivel bottom plate 8 in the state which the spring body 112 is elastically deformed. The first bent portion 114 and the second bent portion 116 may be hooked on the first latch 88 with the first latch 88 therebetween, as shown in FIG. 11. In this case, the second latch 108 may be disposed between the first bent portion 114 and the second bent portion 116.

When the first bent portion 114 and the second bent portion 116 are hooked to the first latch 88, arbitrary separation of the spring 11 may be restricted, and the spring 11 may be maintained at an upper side of the swivel bottom plate 8, particularly, the accommodation portion 85.

In the above state, the user may swivel the display set 1 around the vertical central axis, i.e., the bolt 12, and the swivel top plate 5, the swivel top bracket 6, and the stopper plate 10 connected by the bolt 12 and the nut 13 may rotate together.

When the stopper plate 10 rotates, the second latch 108 may push one of the first contact part 114 and the second contact part 116, as shown in FIG. 12, and the spring 11 may be further elastically deformed, as shown in (C) of FIG. 10. In this case, a distance between the first bent portion 114 and the second bent portion 116 may be further apart from each other than before the rotation of the stopper plate 10.

Hereinafter, a swivel operation of the display device is described as follows.

The user or operator may place the swiveling mechanism 2 on the installation surface, and the elastic member 9 of the swiveling mechanism 2 may be in surface contact with the installation surface, and the movement of the display set 1 and the swiveling mechanism 2 may be restricted.

With the elastic member 9 placed on the installation surface, the user or operator may hold the display set 1 to swivel the display set 1 in a clockwise or counterclockwise direction, and the front of the display set 1 may face a front left side of the display set 1 or a front right side of the display set 1.

When the display set 1 is swiveled, the swivel top plate 5 coupled to the display set 1 and the swivel top bracket 6 coupled to the swivel top plate 5 may rotate. When the swivel top bracket 6 rotates, the first gear 61 may rotate around the bolt 12 along with the second gear 71 of the swivel bottom bracket 7, and the stopper plate 10 may rotate around the bolt 12.

When the stopper plate 10 rotates, the stopper plate 10 may push either the first bent portion 114 or the second bent portion 116 of the spring 11 in the rotational direction (clockwise or counterclockwise direction), and the spring body 112 of the spring 11 may be elastically deformed.

In this case, the spring 11 is not elastically restored by the load of the display set 1, the swivel top plate 5, the swivel top bracket 6, and the engagement of the first gear 61 and the second gear 71, and may be maintained in the elastically deformed state, as shown in (c) of FIG. 10.

That is, the user or operator may change a front angle of the display set 1 by a simple operation of swivel the display set 1.

The user or operator may hold the display set 1 to lift the display set 1 upward, and when the swiveling mechanism 2 is lifted from the installation surface, the swivel bottom bracket 7 may droop by its own weight together with the swivel bottom plate 8, as shown in FIG. 10, a portion of the accommodation portion 85 may be placed on the contact part 106 of the stopper plate 10, and the second gear 71 of the swivel bottom bracket 7 may be separated from the first gear 61 of the swivel top bracket 6. In this case, as shown in (d) of FIG. 10, the spring 11 may be elastically restored, and either the first bent portion 114 or the second bent portion 116 may allow the stopper plate 10 to reversely rotate to its original point (original position).

That is, the user or operator may allow the swiveling mechanism 2 to return to the original portion by the simple operation of holding the display set 1 to lift the display set 1 upward.

The above-disclosed subject matter is to be considered illustrative, and not restrictive, and the appended claims are intended to cover all such modifications, enhancements, and other embodiments, which fall within the true spirit and scope of the present disclosure.

Thus, the embodiment of the present disclosure is to be considered illustrative, and not restrictive, and the technical spirit of the present disclosure is not limited to the foregoing embodiment.

Therefore, the scope of the present disclosure is defined not by the detailed description of the invention but by the appended claims, and all differences within the scope will be construed as being included in the present invention.

1. A display device comprising:
a display set; and
a swiveling mechanism connected to the display set,
wherein the display set comprises a display body and a stand connected to the display body, and
the swiveling mechanism comprises:
a swivel top plate coupled to the stand;
a swivel top bracket disposed below the swivel top plate and having a first gear;
a swivel bottom bracket having a second gear with which the first gear is detachably engaged;
a swivel bottom plate coupled to the swivel bottom bracket;
an elastic member provided at a bottom surface of the swivel bottom plate and placed on an installation surface;
a stopper plate disposed on the bottom surface of the swivel bottom plate;
a bolt passing through the swivel top plate, the swivel top bracket, and the stopper plate;
a nut coupled to the bolt; and
a spring supported by the swivel bottom plate and elastically deformed by the stopper plate.

2. The display device according to claim 1, wherein the first gear is disposed on a bottom surface of the swivel top bracket, and
the second gear is disposed on a top surface of the swivel bottom bracket.

3. The display device according to claim 1, wherein a bolt through-hole through which the bolt passes is defined in each of the swivel top plate, the swivel top bracket, and the stopper plate.

4. The display device according to claim 1, wherein an accommodation portion in which the stopper plate is accommodated is provided in the swivel bottom plate.

5. The display device according to claim 4, wherein a space in which the accommodation portion is accommodated is defined between the swivel top bracket and the stopper plate.

6. The display device according to claim 4, wherein, in the swivel bottom bracket, an opening that surrounds the accommodation portion is defined larger than the accommodation portion.

7. The display device according to claim 1, wherein a spring space in which the spring is accommodated is defined between the swivel top bracket and the swivel bottom plate.

8. The display device according to claim 1, wherein the spring comprises:
a spring body;
a first bent portion bent at one side of the spring body; and
a second bent portion bent at the other side of the spring body.

9. The display device according to claim 8, wherein a first latch that is in contact with the first bent portion and the second bent portion is provided on the swivel bottom plate, and
a second latch that is in contact with one of the first bent portion and the second bent portion is provided on the stopper plate.

10. The display device according to claim 9, wherein the second latch is disposed to face the first latch in a horizontal direction.

11. The display device according to claim 9, wherein an accommodation groove in which an upper end of the first latch and an upper end of the second latch are accommodated is defined in a bottom surface of the swivel top bracket.

12. The display device according to claim 1, wherein a swivel bottom plate accommodation portion into which the swivel bottom plate is inserted to be accommodated is defined in the swivel bottom bracket.

13. The display device according to claim 1, wherein a stopper portion protrudes from the swivel bottom plate, and
a stopper groove hooked with the stopper portion when the swivel top plate excessively rotates is defined in the swivel top plate.

14. The display device according to claim 13, wherein a stopper portion through-hole through which the stopper portion passes is defined in the swivel bottom bracket.
